(19) United States
(12) Patent Application Publication
(10) Pub. No.: US 2019/0319354 A1
(43) Pub. Date: Oct. 17, 2019

(54) Antenna

(71) Applicant: Huawei Technologies Co., Ltd., Shenzhen (CN)

(72) Inventors: Yuzhen Zhang, Wuhan (CN); Kemeng Wang, Wuhan (CN); Yiwen Gong, Shanghai (CN); Chaoxu Li, Shenzhen (CN); Fang Xia, Wuhan (CN)

(21) Appl. No.: 16/310,607

(22) PCT Filed: Jun. 17, 2016
(86) PCT No.: PCT/CN2016/086287

§ 371 Date: Dec. 17, 2018

(51) Int. Cl. H01Q 3/24; H01Q 9/28; H01Q 15/14; H01Q 3/44

(52) U.S. Cl. CPC H01Q 3/24; H01Q 3/446; H01Q 15/148; H01Q 9/285

(57) ABSTRACT

An antenna includes a director-reflector unit, which includes two radiation elements, and a switch, and a main element configured to transmit and receive a signal. Total electrical length of the two radiation elements is greater than one half of a wavelength corresponding to an operating frequency band of the antenna, and electrical length of either of the two radiation elements is less than one half of the wavelength corresponding to the operating frequency band of the antenna. The two radiation elements are coupled using the switch and the director-reflector unit is used as a reflector and configured to reflect the signal transmitted and received by the main element when the switch is switched on, and the two radiation elements are decoupled and the director-reflector unit is used as a director and configured to direct the signal transmitted and received by the main element when the switch is switched off.

### TECHNICAL FIELD

The present invention relates to the field of terminal technologies, and in particular, to an antenna.

### BACKGROUND

An antenna is a converter that converts a guided electromagnetic wave propagated on a transmission line into an electromagnetic wave propagated in an unbound medium (usually free space) or performs reverse conversion. The antenna is a component configured to transmit or receive an electromagnetic wave in a wireless device.

Currently, widely used antennas include directional antennas and omnidirectional antennas. A directional antenna has strong radiation in one or more specific directions, but extremely weak radiation in another direction. The directional antenna has a relatively high gain only in a specific direction. An omnidirectional antenna implements 360-degree even radiation on a horizontal plane, but has a relatively small gain.

However, in many scenarios, the antenna is required to implement 360-degree high-gain radiation on the horizontal plane. For example, in a smart home system, user terminals may be distributed in any position in a house. To ensure that all the user terminals can implement communication, an antenna disposed in a router needs to provide full coverage on the horizontal plane. In addition, because an obstacle such as a wall may be disposed between the user terminals, the antenna also requires a high gain to ensure reliability of communication. Therefore, designing an antenna having 360-degree high-gain radiation on the horizontal plane becomes a popular research.

### SUMMARY

Embodiments of the present invention disclose an antenna, so as to implement 360-degree high-gain radiation on a horizontal plane.

According to a first aspect, an embodiment of the present invention provides an antenna. The antenna includes a main element and at least one director-reflector unit; the main element is configured to transmit and receive a signal; the director-reflector unit includes a first radiation element, a second radiation element, and a switch, where total electrical length of the first radiation element and the second radiation element is greater than one half of a wavelength corresponding to an operating frequency band of the antenna, and both electrical length of the first radiation element and electrical length of the second radiation element are less than one half of the wavelength corresponding to the operating frequency band of the antenna; when the switch is switched on, one end of the first radiation element is connected to one end of the second radiation element by using the switch, and the director-reflector unit is used as a reflector and configured to reflect the signal transmitted and received by the main element; and when the switch is switched off, the first radiation element is disconnected from the second radiation element, and the director-reflector unit is used as a director and configured to direct the signal transmitted and received by the main element. When the director-reflector unit is used as the director, a gain of the antenna in a pointed-to direction can be enhanced. When the director-reflector unit is used as the reflector, the gain of the antenna in a reflection direction can be enhanced. That is, when the director-reflector unit is in a different state, the gain of the antenna in a different direction can be enhanced. In addition, a status of the director-reflector unit is variable (that is, the director-reflector unit may be controlled by using the switch to act as the director or the reflector); therefore, the antenna can implement 360-degree high-gain coverage on a horizontal plane by switching the status of the director-reflector unit.

In a possible design, a distance between the director-reflector unit and the main element is less than five-sixteenths of the wavelength corresponding to the operating frequency band of the antenna, and the distance is greater than three-sixteenths of the wavelength corresponding to the operating frequency band of the antenna. Setting the distance between the director-reflector unit and the main element in this way can better improve a 360-degree gain effect of the antenna on the horizontal plane. When the distance between the director-reflector unit and the main element of the antenna is equal to a quarter of the wavelength corresponding to the operating frequency band of the antenna, an effect of improving the 360-degree gain effect of the antenna on the horizontal plane is relatively good.

In a possible design, the antenna includes n director-reflector units that are disposed around the main element, where n is an integer greater than 1. Disposing the director-reflector units around the main element helps improve the 360-degree gain effect of the antenna on the horizontal plane.

In a possible design, there is an equal distance between each of the n director-reflector units and the main element, and there is an equal distance between adjacent director-reflector units. Setting the equal distance between each director-reflector unit and the main element and the equal distance between adjacent director-reflector units can achieve a relatively good gain effect of the antenna. Optionally, there may be a different distance between each director-reflector unit and the main element, or there may be a different distance between adjacent director-reflector units. This can also increase the gain of the antenna.

In a possible design, the switch is connected to a signal control chip, and the signal control chip is configured to control switch-on or switch-off of the switch. This manner can help control switch-off or switch-on of the switch. Optionally, the antenna may further include an infrared sensor. The infrared sensor is configured to detect whether there is a user in each direction on the horizontal plane. When it is detected that there is a user in a direction or that a quantity of users in a direction exceeds a preset value, the signal control chip controls a corresponding switch to be switched on or off, so as to increase a gain in the direction. Optionally, the antenna may further include a distance sensor. When it is detected, by using the distance sensor, that a user moves towards a direction or that a quantity of users moving towards a direction is greater than a preset value, the signal control chip controls a corresponding switch to be switched on or off, so as to implement dynamical monitoring and flexibly change gain of the antenna in a specific direction.

In a possible design, the main element is a dipole or a loop antenna. The dipole or the loop antenna itself can implement 360-degree full coverage on the horizontal plane. In this way, with the help of the director-reflector unit, the gain of the antenna on the horizontal plane can be more significantly increased.

In a possible design, the first radiation element and the second radiation element are capable of implementing electromagnetic conversion.

In a possible design, the first radiation element and the second radiation element are in a rectangular or serpentine shape.

In a possible design, the switch is a radio frequency switch and operates on an operating frequency band of the main element.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a schematic diagram of directing a signal by a director;

FIG. 2 is a schematic diagram of reflecting a signal by a reflector;

FIG. 3 is a schematic structural diagram of an antenna according to an embodiment of the present invention;

FIG. 4 is a schematic diagram of an application scenario according to an embodiment of the present invention;

FIG. 5 is a horizontal-plane directivity pattern of an antenna in three antenna states according to an embodiment of the present invention;

FIG. 6 is a horizontal-plane directivity pattern of an antenna when three antenna states are combined according to an embodiment of the present invention;

FIG. 7 is a schematic diagram of an antenna model according to an embodiment of the present invention; and

FIG. 8 is a schematic detail diagram of a director-reflector unit according to an embodiment of the present invention.

### DESCRIPTION OF EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

An antenna provided in the embodiments of the present invention may be used in various terminals that require wireless communication, for example, a router, a home gateway, a set-top box, an in-vehicle device, or the like. The terminal may include a central processing unit, a baseband circuit, a radio frequency circuit, and the like. Using an example in which the terminal sends a signal, the baseband circuit transmits, to the radio frequency circuit, a signal that needs to be sent, the radio frequency circuit performs steps of filtering, modulation, matching, and so on, and feeds the signal to an input end of the antenna, and the antenna performs radiation towards free space. A process of receiving a signal by the terminal is a process opposite to the foregoing sending process, and details are not described herein.

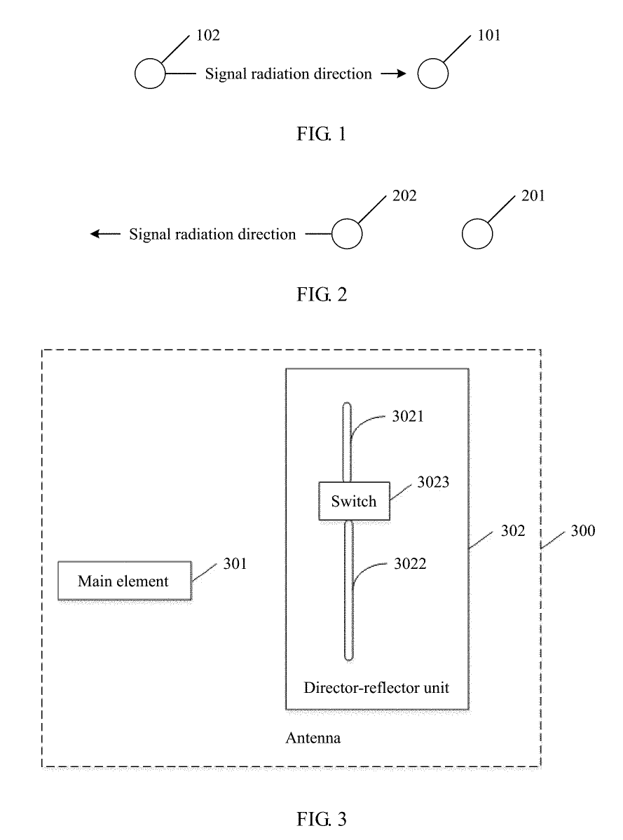

For a better understanding of the embodiments of the present invention, the following describes a director and a reflector included in the embodiments of the present invention with reference to FIG. 1 and FIG. 2.

In an actual application, the director is disposed in a maximum radiation direction of a main element (the main element refers to a component, configured to receive and transmit a signal, of an antenna, and the main element is electrically connected to a signal feed-in source), and is configured to direct a signal received or transmitted by the main element, so as to enhance a gain of the antenna in the maximum radiation direction. The reflector is disposed in an opposite direction of the maximum radiation direction of the main element, and is configured to reflect the signal received or transmitted by the main element, so as to enhance the gain of the antenna in the maximum radiation direction. The gain is used to measure a capability of the antenna in receiving and transmitting a signal in a specific direction. Therefore, a higher gain in a direction indicates a stronger capability of the antenna in receiving and transmitting a signal in the direction.

For example, FIG. 1 is a schematic diagram of directing a signal by a director. As shown in FIG. 1, a radiated-to direction of an antenna is towards a right side of a main element 102 (that is, a direction pointing from 102 to 101). Therefore, a director 101 is disposed within a radiated-to direction of the main element 102, to direct a signal radiated by the main element 102 to a signal radiation direction indicated by an arrow shown in FIG. 1, so that a signal in the signal radiation direction can be enhanced, and a gain of the antenna in the direction is further increased. FIG. 2 is a schematic diagram of reflecting a signal by a reflector. A corresponding radiated-to direction of an antenna in FIG. 2 is towards a left side of a main element 202. Therefore, a reflector 201 is disposed in a direction opposite to a radiated-to direction of the main element 202. The reflector 201 may reflect a signal radiated by the main element 202 to a signal radiation direction indicated by an arrow shown in FIG. 2, so that a signal in the signal radiation direction is enhanced, and a gain of the antenna in the direction is further increased. It should be noted that the “maximum radiation direction” and the “radiated-to direction” mentioned herein may be used interchangeably and represent a same meaning.

In an actual application, in an antenna that includes a radiation element (the radiation element refers to an object capable of implementing electromagnetic conversion) and the main element, when a distance between the radiation element and the main element is properly set, whether the radiation element is used as the director or the reflector may be determined according to electrical length of the radiation element. When the electrical length of the radiation element is slightly less than one half of a wavelength corresponding to an operating frequency band of the antenna, the radiation element may be used as the director. When the electrical length of the radiation element is slightly greater than one half of the wavelength corresponding to the operating frequency band of the antenna, the radiation element may be used as the reflector.

The following further describes this embodiment of the present invention in detail based on the foregoing descriptions of the director and the reflector.

An embodiment of the present invention provides an antenna. FIG. 3 is a schematic structural diagram of the antenna according to this embodiment of the present invention. Referring to FIG. 3, an antenna 300 includes a main element 301 and at least one director-reflector unit 302. The main element 301 is configured to transmit and receive a signal. The director-reflector unit 302 includes a first radiation element 3021, a second radiation element 3022, and a switch 3023. Total electrical length of the first radiation element 3021 and the second radiation element 3022 is greater than one half of a wavelength corresponding to an operating frequency band of the antenna 300. Both electrical length of the first radiation element 3021 and electrical length of the second radiation element 3022 are less than one half of the wavelength corresponding to the operating frequency band of the antenna 300. When the switch 3023 is switched on, one end of the first radiation element 3021 is connected to one end of the second radiation element 3022 by using the switch 3023, and the director-reflector unit 302 is used as a reflector and configured to reflect the signal transmitted and received by the main element 301. When the switch 3023 is switched off, the first radiation element 3021 is disconnected from the second radiation element 3022, and the director-reflector unit 302 is used as a director and configured to direct the signal transmitted and received by the main element 301.

In this embodiment of the present invention, the director-reflector unit 302 is not electrically connected to a signal feed-in source.

In this embodiment of the present invention, the first radiation element 3021 and the second radiation element 3022 are capable of implementing electromagnetic conversion, and the first radiation element 3021 and the second radiation element 3022 are capable of radiating an electromagnetic wave.

In this embodiment of the present invention, whether the director-reflector unit 302 is used as the director or the reflector may be set by controlling switch-on or switch-off of the switch 3023. When the switch 3023 is switched on, one end of the first radiation element 3021 is connected to one end of the second radiation element 3022 by using the switch 3023, and the total electrical length of the first radiation element 3021 and the second radiation element 3022 is greater than one half of the wavelength corresponding to the operating frequency band of the antenna 300. Therefore, at this time, electrical length of the director-reflector unit 302 is greater than one half of the wavelength corresponding to the operating frequency band of the antenna 300, and the director-reflector unit 302 is used as the reflector. When the switch 3023 is switched off, the first radiation element 3021 is disconnected from the second radiation element 3022, and both the electrical length of the first radiation element 3021 and the electrical length of the second radiation element 3022 are less than one half of the wavelength corresponding to the operating frequency band of the antenna 300. Therefore, at this time, the electrical length of the director-reflector unit 302 is less than one half of the wavelength corresponding to the operating frequency band of the antenna 300, and the director-reflector unit 302 is used as the director.

In an optional implementation, the switch 3023 is connected to a signal control chip, and the signal control chip is configured to control switch-on or switch-off of the switch. This manner can help control switch-off or switch-on of the switch. Optionally, the switch 3023 is a radio frequency switch and operates on an operating frequency band of the main element 301. For example, the switch 3023 may be specifically a PIN diode switch or a single pole double throw switch. Optionally, the antenna 300 may further include an infrared sensor. The infrared sensor is configured to detect whether there is a user in each direction on the horizontal plane. When it is detected that there is a user in a direction or that a quantity of users in a direction exceeds a preset value, the signal control chip controls a corresponding switch 3023 to be switched on or off, so as to increase a gain in the direction. Optionally, the antenna 300 may further include a distance sensor. When it is detected, by using the distance sensor, that a user moves towards a direction or that a quantity of users moving towards a direction is greater than a preset value, the signal control chip controls a corresponding switch 3023 to be switched on or off, so as to increase a gain in the direction.

In this embodiment of the present invention, when the director-reflector unit 302 is used as the director, a gain of the antenna 300 in a pointed-to direction can be enhanced. When the director-reflector unit 302 is used as the reflector, the gain of the antenna 300 in a reflection direction can be enhanced. That is, when the director-reflector unit 302 is in a different state, the gain of the antenna 300 in a different direction can be enhanced. In addition, a status of the director-reflector unit 302 is variable (that is, the director-reflector unit 302 may be controlled by using the switch 3023 to act as the director or the reflector); therefore, the antenna can implement 360-degree high-gain coverage on the horizontal plane by switching the status of the director-reflector unit 302.

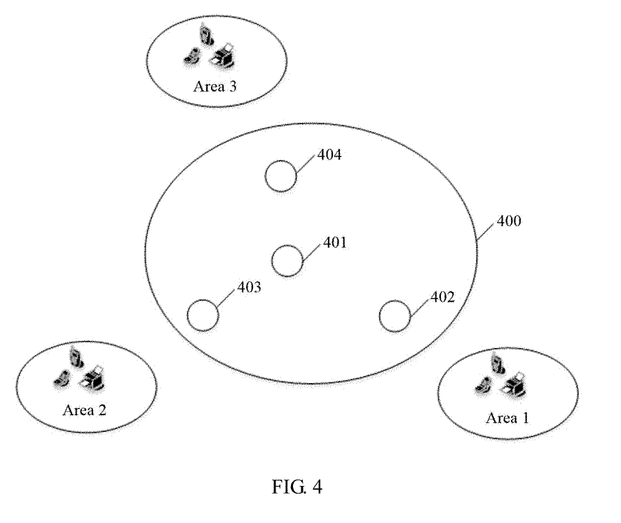

The following uses an antenna shown in FIG. 4 as an example to specifically describe how the antenna implements 360-degree high-gain coverage on a horizontal plane by switching a status of a director-reflector unit.

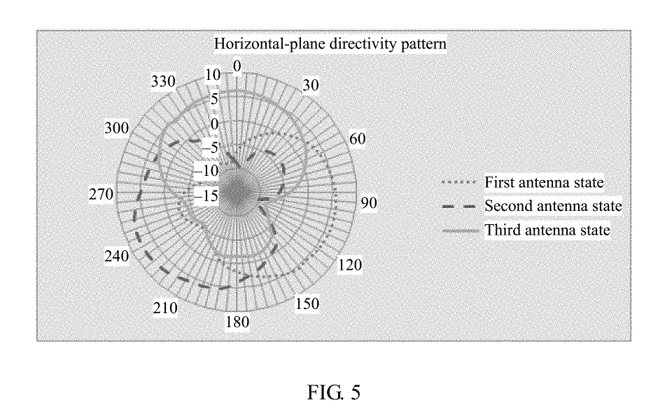

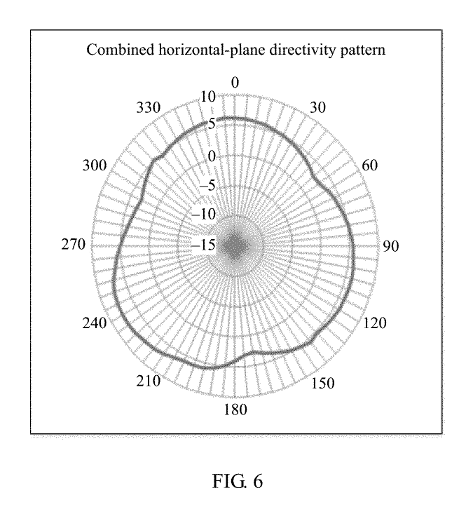

FIG. 4 is a schematic diagram of an application scenario according to an embodiment of the present invention. As shown in FIG. 4, an antenna 400 includes a main element 401 and has three director-reflector units, namely a director-reflector unit 402, a director-reflector unit 403, and a director-reflector unit 404. The three director-reflector units are disposed around the main element 401. In an actual application, 360-degree high-gain coverage on a horizontal plane can be implemented by switching between the following three antenna states. In a first antenna state, the director-reflector unit 402 is used as a director, and the director-reflector unit 403 and the director-reflector unit 404 are used as reflectors. In a second antenna state, the director-reflector unit 403 is used as a director, and the director-reflector unit 402 and the director-reflector unit 404 are used as reflectors. In a third antenna state, the director-reflector unit 404 is used as a director, and the director-reflector unit 402 and the director-reflector unit 403 are used as reflectors. As shown in FIG. 5, FIG. 5 shows a directivity pattern of the antenna on the horizontal plane in the three antenna states. As shown in FIG. 6, FIG. 6 shows a directivity pattern of the antenna on the horizontal plane when the three antenna states are combined. It can be learned that the antenna can implement 360-degree high-gain coverage on the horizontal plane by switching between the three antenna states.

In an actual application, a state of the director-reflector unit 302 may be switched according to a location relationship between a user terminal and the antenna, so that the user terminal receives a high-quality signal, or a signal sent by the user terminal can be better received. For example, when the user terminal is in an area 1 shown in FIG. 4, the antenna state may be switched to the first state. In this case, the antenna has a high gain in a direction in which the user terminal is located, so that the user terminal can receive a high-quality signal, or a signal sent by the user terminal can be better received. Likewise, when the user terminal moves to an area 2, the antenna state may be switched to the second state, and when the user terminal moves to an area 3, the antenna state may be switched to the third state.

In this embodiment of the present invention, more director-reflector units may be further disposed to increase a minimum gain of a horizontal-plane directivity pattern and improve non-circularity of the directivity pattern. For example, six director-reflector units may be disposed around the main element. Adjacent two director-reflector units are used as directors, and the other four are used as reflectors. Then, there are a total of six antenna states, corresponding to six radiation directivity patterns. 360-degree high-gain full coverage on the horizontal plane can be implemented by switching between the six antenna states.

It should be noted that the antenna directivity patterns shown in FIG. 5 and FIG. 6 are merely an example. In an actual application, with a change in such factors as a distance between a director-reflector unit and the main element and a distance between director-reflector units, an appropriate change may be made to FIG. 5 and FIG. 6.

In an optional implementation, the distance between the director-reflector unit and the main element of the antenna is less than five-sixteenths of the wavelength corresponding to the operating frequency band of the antenna, and the distance between the director-reflector unit and the main element is greater than three-sixteenths of the wavelength corresponding to the operating frequency band of the antenna. Setting the distance between the director-reflector unit and the main element in this way can better improve a 360-degree gain effect of the antenna on the horizontal plane. When the distance between the director-reflector unit and the main element of the antenna is equal to a quarter of the wavelength corresponding to the operating frequency band of the antenna, an effect of improving the 360-degree gain effect of the antenna on the horizontal plane is the best.

For example, for the antenna 400 shown in FIG. 4, a distance between the director-reflector unit 402 and the main element 401 is less than five-sixteenths of a wavelength corresponding to an operating frequency band of the antenna 400, and the distance is greater than three-sixteenths of the wavelength corresponding to the operating frequency band of the antenna 400. A distance between the director-reflector unit 403 and the main element 401 is less than five-sixteenths of the wavelength corresponding to the operating frequency band of the antenna 400, and the distance is greater than three-sixteenths of the wavelength corresponding to the operating frequency band of the antenna 400. A distance between the director-reflector unit 404 and the main element 401 is less than five-sixteenths of the wavelength corresponding to the operating frequency band of the antenna 400, and the distance is greater than three-sixteenths of the wavelength corresponding to the operating frequency band of the antenna 400.

In an optional implementation, the antenna includes n director-reflector units that are disposed around the main element, where n is an integer greater than 1. For the antenna 400 shown in FIG. 4, the director-reflector unit 402, the director-reflector unit 403, and the director-reflector unit 404 are disposed around the main element 401. This helps improve the gain effect of the antenna.

In an optional implementation, there is an equal distance between each of the n director-reflector units and the main element, and there is an equal distance between adjacent director-reflector units. For the antenna 400 shown in FIG. 4, the distance between the director-reflector unit 402 and the main element 401 is equal to the distance between the director-reflector unit 403 and the main element 401. The distance between the director-reflector unit 403 and the main element 401 is equal to the distance between the director-reflector unit 404 and the main element 401. A distance between the director-reflector unit 402 and the director-reflector unit 403 is equal to a distance between the director-reflector unit 402 and the director-reflector unit 404. The distance between the director-reflector unit 402 and the director-reflector unit 403 is equal to a distance between the director-reflector unit 403 and the director-reflector unit 404. Setting an equal distance between each director-reflector unit and the main element 401 and an equal distance between adjacent director-reflector units can achieve a best gain effect of the antenna. Certainly, optionally, there may be a different distance between each director-reflector unit and the main element, or there may be a different distance between adjacent director-reflector units. This can also increase the gain of the antenna, but the gain effect is not the best.

In an optional implementation, the main element may be a dipole or a loop antenna. The dipole or the loop antenna itself can implement 360-degree full coverage on the horizontal plane. In this way, with the help of the director-reflector unit, the gain of the antenna on the horizontal plane can be more significantly increased.

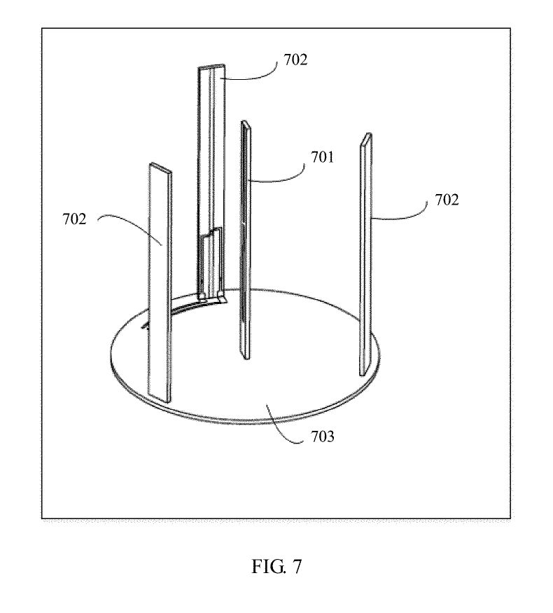

Referring to FIG. 7, FIG. 7 is a schematic diagram of an antenna model according to an embodiment of the present invention. As shown in FIG. 7, a main element 701 of an antenna 700 and three director-reflector units 702 are secured on a horizontally disposed dielectric plate 703. The dielectric plate 703 shown in FIG. 7 is circular. In an actual application, a dielectric plate may also be in another shape.

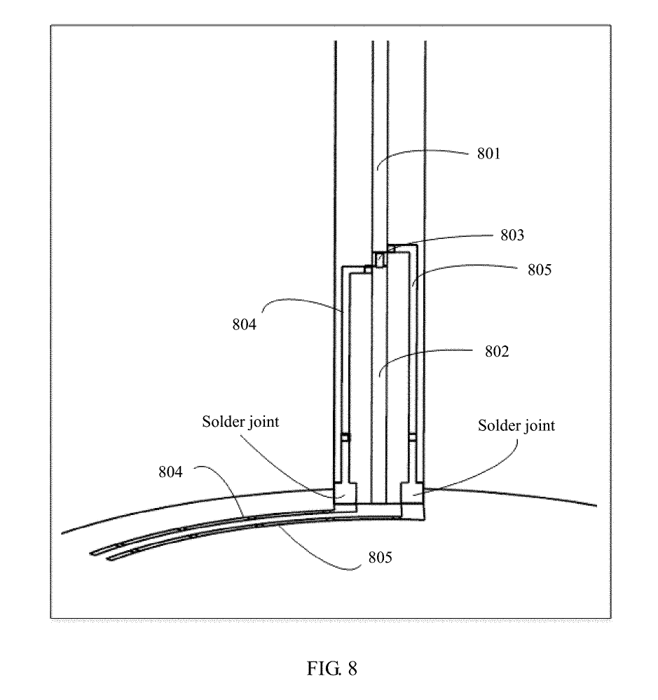

Referring to FIG. 8, FIG. 8 is a schematic detail diagram of the director-reflector unit 702. In a schematic diagram of a model shown in FIG. 8, the director-reflector unit 702 includes a first radiation element 801, a first radiation element 802, and a switch 803. The first radiation element 801 and the first radiation element 802 are in a rectangular shape. In an actual application, the first radiation element 801 and the first radiation element 802 may also be in a serpentine shape or another shape, provided that total electrical length of the first radiation element 801 and the first radiation element 802 is greater than one half of a wavelength corresponding to an operating frequency band of the antenna 700, and both electrical length of the first radiation element 801 and electrical length of the first radiation element 802 are less than one half of the wavelength corresponding to the operating frequency band of the antenna 700.

A joint between the director-reflector unit 702 and the dielectric plate 703 may be secured by means of wave soldering or manual soldering. A control signal line 804 is connected to the dielectric plate 703 by using a solder joint and is connected to a main board by using a flat cable. A reference ground cable 805 is connected to the dielectric plate 703 by using a solder joint and is connected to the main board by using a flat cable.

In this embodiment of the present invention, the director-reflector unit 702 does not need to be grounded by using the dielectric plate 703. The dielectric plate plays a role of securing the main element 701 and the three director-reflector units 702 and routing a control line.

It should be noted that FIG. 7 and FIG. 8 illustrate only an example of an antenna model, but do not impose limitation on the antenna model. In an actual application process, the antenna model may also be set according to an actual requirement.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1.-9. (canceled)

10. An antenna, comprising:
a main element configured to transmit and receive a signal; and
at least one director-reflector unit coupled to the main element and comprising:
a first radiation element;
a second radiation element, a total electrical length of the first radiation element and the second radiation element being greater than one half of a wavelength corresponding to an operating frequency band of the antenna, and both an electrical length of the first radiation element and an electrical length of the second radiation element being less than the one half of the wavelength corresponding to the operating frequency band of the antenna; and
a switch, one end of the first radiation element being coupled to one end of the second radiation element using the switch and the at least one director-reflector unit being used as a reflector and configured to reflect the signal transmitted and received by the main element when the switch is switched on, and the first radiation element being decoupled from the second radiation element and the at least one director-reflector unit being used as a director and configured to direct the signal transmitted and received by the main element when the switch is switched off.

11. The antenna of claim 10, wherein a distance between the at least one director-reflector unit and the main element is less than five-sixteenths of the wavelength corresponding to the operating frequency band of the antenna, and the distance being greater than three-sixteenths of the wavelength corresponding to the operating frequency band of the antenna.

12. The antenna of claim 10, wherein the antenna comprises n director-reflector units disposed around the main element, and the n being an integer greater than one.

13. The antenna of claim 12, wherein a distance between each of the n director-reflector units and the main element is equal, and a distance between adjacent director-reflector units being equal.

14. The antenna of claim 13, wherein the switch is coupled to a signal control chip, and the signal control chip being configured to control the switch.

15. The antenna of claim 10, wherein the main element is a dipole antenna.

16. The antenna of claim 10, wherein the main element is a loop antenna.

17. The antenna of claim 10, wherein the first radiation element and the second radiation element are configured to implement electromagnetic conversion.

18. The antenna of claim 10, wherein the first radiation element and the second radiation element are in a rectangular shape.

19. The antenna of claim 10, wherein the first radiation element and the second radiation element are in a serpentine shape.

20. The antenna of claim 10, wherein the switch is a radio frequency switch and configured to operate on an operating frequency band of the main element.

21. A terminal with an antenna, and the antenna comprising:
a main element configured to transmit and receive a signal; and
at least one director-reflector unit coupled to the main element and comprising:
a first radiation element;
a second radiation element, a total electrical length of the first radiation element and the second radiation element being greater than one half of a wavelength corresponding to an operating frequency hand of the antenna, and both an electrical length of the first radiation element and an electrical length of the second radiation element being less than the one half of the wavelength corresponding to the operating frequency band of the antenna; and
a switch, one end of the first radiation element being coupled to one end of the second radiation element using the switch and the at least one director-reflector unit being used as a reflector and configured to reflect the signal transmitted and received by the main element when the switch is switched on, and the first radiation element being decoupled from the second radiation element and the at least one director-reflector unit being used as a director and configured to direct the signal transmitted and received by the main element when the switch is switched off.

22. The terminal of claim 21, wherein a distance between the director-reflector unit and the main element is less than five-sixteenths of the wavelength corresponding to the operating frequency band of the antenna, and the distance being greater than three-sixteenths of the wavelength corresponding to the operating frequency band of the antenna.

23. The terminal of claim 21, wherein the antenna comprises n director-reflector units disposed around the main element, and the n being an integer greater than one.

24. The terminal of claim 23, wherein a distance between each of the n director-reflector units and the main element is equal, and a distance between adjacent director-reflector units being equal.

25. The terminal of claim 21, wherein the switch is coupled to a signal control chip, and the signal control chip being configured to control the switch.

26. The terminal of claim 21, wherein the first radiation element and the second radiation element are configured to implement electromagnetic conversion.

27. The terminal of claim 21, wherein the first radiation element and the second radiation element are in a rectangular or serpentine shape.

28. The terminal of claim 21, wherein the switch is a radio frequency switch and configured to operate on an operating frequency band of the main element.

29. The terminal of claim 21, further comprising a central processing unit; a baseband circuit; and a radio frequency circuit.
